(19) United States
(12) Patent Application Publication
(10) Pub. No.: US 2024/0414762 A1
(43) Pub. Date: Dec. 12, 2024

(54) TWT OPERATION IN MULTI-AP COORDINATION

(71) Applicant: Samsung Electronics Co., Ltd., Suwon-si (KR)

(72) Inventors: Rubayet Shafin, Allen, TX (US); Boon Loong Ng, Plano, TX (US)

(21) Appl. No.: 18/670,561

(22) Filed: May 21, 2024

Related U.S. Application Data
(60) Provisional application No. 63/472,190, filed on Jun. 9, 2023.

(51) Int. Cl. H04W 74/0816; H04W 8/22; H04W 74/04

(52) U.S. Cl. CPC H04W 74/0816; H04W 8/22; H04W 74/04

(57) ABSTRACT

A first access point (AP) in a wireless network generates an invitation frame to solicit participation in a multi-AP coordination. The invitation frame includes one or more coordination information to share with one or more second APs. The first AP transmits the invitation frame to the one or more second APs. The first AP receives a response frame from the one or more second APs. The first AP forms a multi-AP coordination set including at least one second AP based on the response frame.

### CROSS-REFERENCE TO RELATED APPLICATIONS

This application claims the benefit of priority from U.S. Provisional Application No. 63/472,190, entitled “TARGET WAKE TIME OPERATION WITH COORDINATION AMONG MULTIPLE ACCESS POINTS,” filed Jun. 9, 2023, which is incorporated herein by reference in its entirety.

### TECHNICAL FIELD

This disclosure relates generally to wireless communication systems, and more particularly to, for example, but not limited to, a target wake time (TWT) operation in wireless communication systems.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHZ, 5GHZ, 6GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

An aspect of the present disclosure provides a first access point (AP) in a wireless network. The first AP device comprises a memory and a processor coupled to the memory. The processor is configured to cause: generating an invitation frame to solicit participation in a multi-AP coordination, the invitation frame including one or more coordination information to share with one or more second APs; transmitting the invitation frame to the one or more second APs; receiving a response frame from the one or more second APs; and forming a multi-AP coordination set including at least one second AP based on the response frame.

In some embodiments, the invitation frame includes capability information or limitation information for the first AP.

In some embodiments, the invitation frame includes load information of the first AP.

In some embodiments, the invitation frame includes benefit information that the one or more second APs gain when the one or more second APs participate in the multi-AP coordination.

In some embodiments, the invitation frame indicates that the first AP reciprocates by participating in a multi-AP coordination requested by the one or more second APs.

In some embodiments, the invitation frame indicates a type of a target wake time (TWT) operation that is shared with the one or more second APs.

In some embodiments, the response frame indicates an acceptance, a rejection, or an alternative suggestion in response to the invitation frame.

In some embodiments, the processor is further configured to cause transmitting, to one or more stations (STAs) associated with the first AP, a TWT schedule or a TWT agreement that is aligned with the one or more TWT schedule or TWT agreements transmitted by the one or more second APs that participate in the multi-AP coordination.

In some embodiments, the TWT schedule is a restricted TWT schedule that is associated with latency sensitive traffic.

In some embodiments, the first AP is a transmission opportunity (TXOP) holder, and the processor is further configured to cause ensuring a TXOP ends before a start time of restricted TWT service period that is advertised by the first AP.

An aspect of the present disclosure provides a first access point (AP) in a wireless network. The first AP device comprises a memory and a processor coupled to the memory. The processor configured to cause: receiving, from a second AP, an invitation frame that solicit participation in a multi-AP coordination, the invitation frame including one or more coordination information to share with the first AP; transmitting a response frame to second AP; and participating in the multi-AP coordination.

In some embodiments, the invitation frame includes capability information or limitation information of the second AP.

In some embodiments, the invitation frame includes load information of the second AP.

In some embodiments, the invitation frame includes benefit information that the first AP gains when the first AP participates in the multi-AP coordination.

In some embodiments, the invitation frame indicates that the second AP reciprocates by participating in a multi-AP coordination requested by the first AP.

In some embodiments, the invitation frame indicates a type of a target wake time (TWT) operation that is shared with the first AP.

In some embodiments, the response frame indicates an acceptance or an alternative suggestion in response to the invitation frame.

In some embodiments, the processor is further configured to cause transmitting, to one or more stations (STAs) associated with the first AP, a TWT schedule or a TWT agreement that is aligned with a TWT schedule or a TWT agreement transmitted by the second AP.

In some embodiments, the TWT schedule is a restricted TWT schedule that is associated with latency sensitive traffic.

In some embodiments, the first AP is a transmission opportunity (TXOP) holder, and the processor is further configured to cause ensuring a TXOP ends before a start time of restricted TWT service period that is advertised by the first AP.

### BRIEF DESCRIPTION OF THE DRAWINGS

FIG. 1 shows an example of a wireless network in accordance with an embodiment.

FIG. 2A shows an example of AP in accordance with an embodiment.

FIG. 2B shows an example of STA in accordance with an embodiment.

FIG. 3 shows an example of multi-link communication operation in accordance with an embodiment.

FIG. 4 shows an example architecture for coordinated TWT negotiation in accordance with an embodiment.

FIG. 5 shows another example architecture for C-TWT negotiation in accordance with an embodiment.

FIG. 6 shows an example pre-negotiation phase in Type 1 architecture for C-TWT negotiation in accordance with an embodiment.

FIG. 7 shows an example format of the TWT element in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

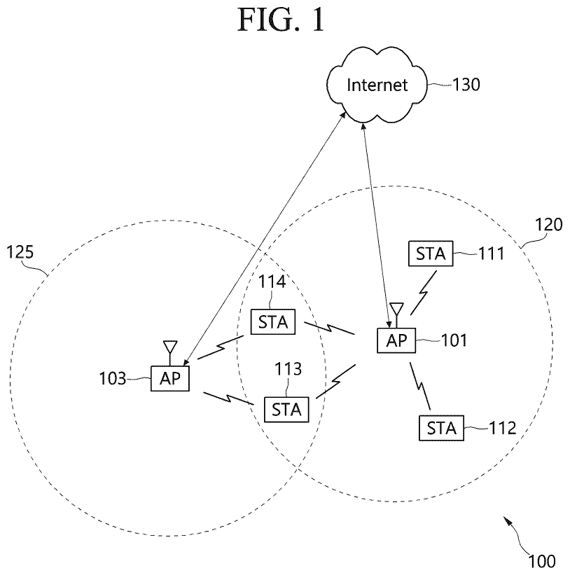

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

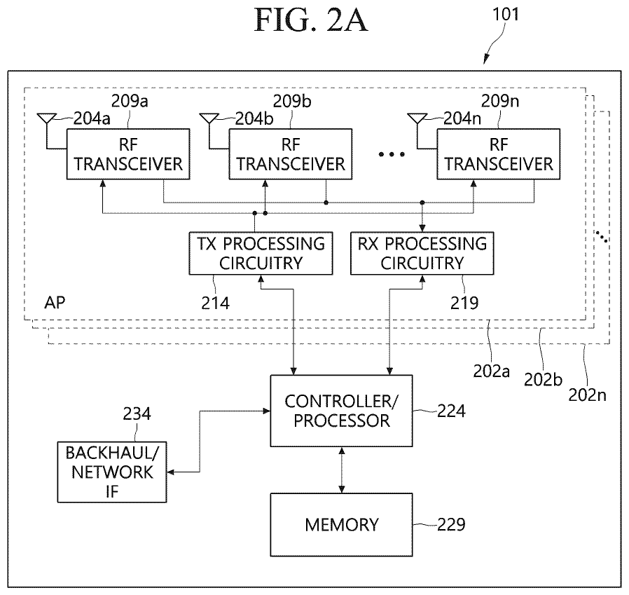

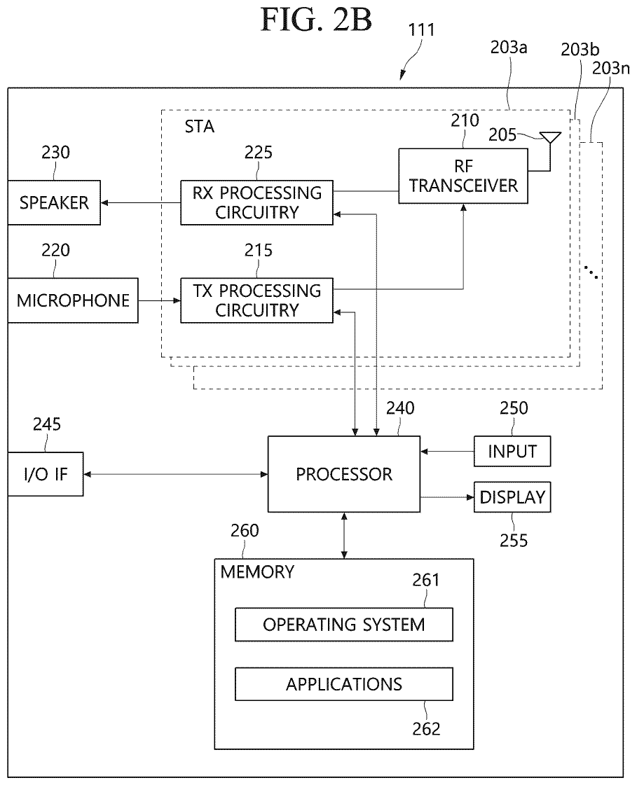

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

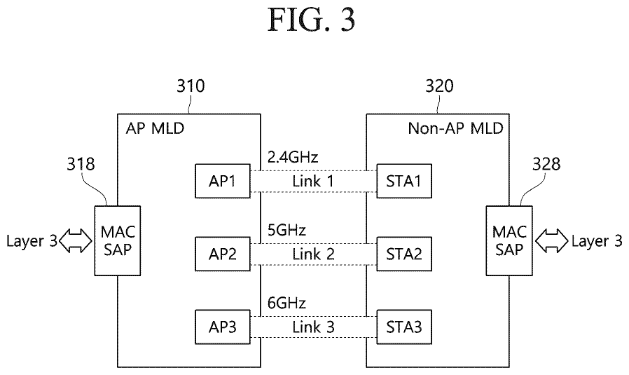

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHZ band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications” and ii) IEEE P802.11be/D3.0, “Wireless LAN Medium Access Control (MAC) and Physical Layer (PHY) Specifications.”

Target wake time (TWT) operation is a feature of power management in WLAN networks. The TWT operation enables an AP to manage activity in the basic service set (BSS) to minimize contention between STAs and reduce required wake times for STAs during the TWT operation. It may be achieved by allocating STAs to operate at non-overlapping times or frequencies and perform frame exchange sequences in pre-scheduled service periods. In the TWT operation, a STA can wake up at pre-scheduled times that have been negotiated with an AP or another STA in the BSS. The STA does not need to be aware of TWT parameter values of other STAs within the BSS or of STAs in other BSSs. The STA does not need to be aware that a TWT service period (SP) is used to exchange frames with other STAs. Frames transmitted during the TWT SP can employ any PPDU (physical layer protocol data unit) format supported by the pair of STAs that have established the corresponding TWT agreement, including, but not limited to, HE MU (high efficiency multi-user) PPDU, HE TB (high efficiency trigger based) PPDU.

IEEE 802.11 standard describes two types of TWT operations: individual TWT operation and broadcast TWT operation. In the individual TWT operation, an individual TWT agreement can be established between two STAs or between a STA and an AP. The negotiation for the individual TWT operation may occur between two STAs or between a STA and an AP on an individual basis. An AP may have TWT agreements with multiple STAs. Any changes in the TWT agreement between the AP and one STA do not affect the TWT agreement between the AP and other STAs.

On the other hand, the broadcast TWT operates in a membership-based approach. In broadcast TWT operation, an AP can set up a shared TWT session for a group of STAs. The AP is typically the controller of the broadcast TWT schedule. The non-AP STAs in the BSS can request membership in the broadcast TWT schedule, or the AP can send unsolicited response to a STA to make the STA a member of the broadcast TWT schedule that the AP maintains in the BSS. The AP may advertise and maintain multiple broadcast TWT schedules in the BSS. When a change is made to any broadcast TWT schedules in the BSS, it may affect all or some of STAs that are members of the corresponding broadcast TWT schedule.

As discussed above, the multi-link operation (MLO) is a key feature for the next generation WLAN. Devices that support the MLO may be referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

TWT enhancements for multi-link devices have recently been discussed in various ways. For example, for individual TWT agreements between two MLDs, a STA affiliated with an MLD, which is a TWT requesting STA, may indicate one or more links that are requested for setting up TWT agreements in the Link ID bitmap subfield of a TWT element in the TWT request. If only one link is indicated in the Link ID bitmap subfield of the TWT element, a single TWT agreement is requested for the STA affiliated with the same MLD, which is operating on the indicated link. A Target Wake Time field of the TWT element may be in reference to the TSF time of the link indicated by the TWT element. Then, a TWT responding STA affiliated with a peer MLD that receives the TWT request including the Link ID bitmap subfield responds with a TWT response indicating one or more links in the Link ID bitmap subfield in the TWT element. The one or more links in the TWT element carried in the TWT response may be the same as the one or more links in the TWT element carried in the TWT request.

Restricted TWT (R-TWT) operation is another important feature for the next generation WLAN. The R-TWT operation provides better support for latency sensitive applications. For instance, traffic in real time applications has stringent requirements in terms of latency and jitter along with certain reliability constraints. Such traffic may be referred to as latency sensitive traffic in this disclosure. The R-TWT operation may offer a protected service period (SP) for R-TWT member STAs by sending Quiet elements to non-member STAs in the BSS in the R-TWT schedule. In some implementations, a quiet interval of the Quiet element overlaps with the initial portion of the R-TWT SP. Therefore, it may provide greater channel access opportunities to R-TWT member STAs than non-member STAs, thereby improving the flow of latency sensitive traffic.

Interference from one BSS may often lead to performance issues for STAs and APs in neighboring BSSs. This interference may result in overall throughput degradation in the network. The Overlapping BSS (OBSS) interference may also increase the overall latency since it takes more time to access the channel due to the interference occupying the channel. If a STA in a BSS has latency-sensitive traffic, this delay in channel access may significantly impede the performance of the STA's latency-sensitive applications. Accordingly, the TWT-based multi-AP coordination can be an important feature for the next generation WLAN. However, as there is currently no framework for TWT based multi-AP coordination, the present disclosure provides a frame for TWT based multi-AP coordination.

In some embodiments, there may be multiple phases for TWT based multi-AP coordination.

### 1. Phase 1: Pre-Negotiation Phase

In Phase 1, a coordinating AP invites other APs for TWT based multi-AP coordination. In some embodiments, the pre-negotiation phase may be optional and therefore omitted. Various embodiments are provided later in this disclosure. In this disclosure, a TWT which is based on multi-AP coordination may be referred to as a Coordinated-TWT (C-TWT).

### 2. Phase 2: Negotiation Phase

In Phase 2, APs participating in the C-TWT negotiation on the multi-AP TWT parameters. An AP that shares its TWT schedule (“sharing AP”) may send a request frame to another AP (“shared AP”) in a multi-AP coordinating AP set. The request frame may comprise various elements or information. In some embodiments, the request frame may comprise a TWT element that includes a TWT parameter set corresponding to a TWT schedule or TWT agreement for which is requested for the multi-AP coordination. In some embodiments, the request frame may include an indication of coordination mode that is a type of assistance requested. For instance, an assistance during the coordinated beamforming, joint transmission for individual TWT, or coordinated spatial use, or an assistance for coordinated scheduling that coordinates TWT schedules or the TWT agreements of AP devices that are not overlapped with a requested TWT schedule or TWT agreement. In some embodiments, the request frame may include additional parameters for requested TWT schedule or TWT agreement, such as power level, operating frequency. In some embodiments, the shared AP may send a response frame to the sharing AP, indicating acceptance or rejection for the request. In some embodiments, the shared AP may send an alternative set of parameters to the sharing AP. The request frame and the response frame may be exchanged directly between the sharing AP and the shared AP. Alternatively, the request frame and the response frame may be exchanged through a central controller that manages APs in the multi-AP coordinating AP set.

### 3. Phase 3: Advertisement of the Negotiated Schedule

In Phase 3, the shared AP advertises the negotiated schedule to associated non-AP STAs in its BSS. The sharing AP also advertises the negotiated schedule to associated non-AP STAs in its BSS.

4. Phase 4: Managing the Coordinated Schedule

In Phase 4, when the sharing AP makes any changes to the TWT schedule, the sharing AP may initiate another negotiation phase with the shared AP. Additionally, the sharing AP may modify the TWT schedule or the TWT agreement by transmitting a TWT Information frame to associated STAs in the BSS. In some embodiments, when there are changes to the TWT schedule or the TWT agreement, the sharing AP may transmit a corresponding TWT Information frame to the shared AP. In this scenario, the shared AP may respond by sending a frame indicating whether the shared AP accepts or rejects the changes to the TWT parameters requested by the sharing AP. When the shared AP does not accept the request for changes, the shared AP may suggest an alternative changes to the sharing AP.

According to some embodiments, in the pre-negotiation phase (Phase 1), a first AP may transmit a first message to one or more other neighboring APs in the vicinity of the first AP. The first message may be referred to as a C-TWT invitation frame in this disclosure. The C-TWT invitation frame can be sent as a unicast frame to the other APs. In some implementations, the C-TWT invitation frame can be sent as a multicast frame or a broadcast frame to the other APs.

In some embodiments, the C-TWT invitation frame may include various information associated with TWT based multi-AP coordination, including, but not limited to, details about capabilities and limitations of the AP that sends the C-TWT invitation frame. The capabilities may include spatial stream transmission capability (e.g., number of RF chains) and supported features, such as Enhanced multi-link single radio (EMLSR) operation and Enhanced multi-link multi-radio (EMLMR) operation. The limitations may include, for example, non-simultaneous transmit and receive (NSTR) operation.

In some embodiments, the C-TWT invitation frame may also include other various information, including, but not limited to, some or all of the followings:
i) basic information on the nature of the BSS operated by the AP sending the C-TWT invitation frame;
ii) load information of the BSS operated by the AP sending the C-TWT invitation frame. In some implementations, the load information can be in the form of a number of STAs associated with the AP or overall traffic characteristics of the STAs associated with the AP;
iii) information related to peer-to-peer STAs that are operating in the BSS operated by the AP that sends the C-TWT invitation frame;
iv) information related to a time duration and bandwidth that are used by peer-to-peer STAs in the BSS operated by the AP that sends the C-TWT invitation frame; and
v) information related to the urgency of traffic in the BSS operated by the AP that sends the C-TWT invitation frame.

According to some embodiments, when a first AP transmits a C-TWT invitation frame to a second AP, the first AP may indicate the benefit that the second AP would gain if the second AP participates in the TWT based multi-AP coordination with the first AP. In some implementations, the first AP may indicate that if the second AP agrees to coordinate with or support the first AP on a certain number of TWT schedule or TWT agreements in the BSS operated by the first AP, the first AP can reciprocate by coordinating or supporting with the second AP on an equal or equivalent number of TWT schedule or TWT agreements in the BSS operated by the second AP. In some implementations, the first AP may indicate that if the second AP agrees to coordinate or support with the first AP on X number of TWT schedules or TWT agreements in the BSS operated by the first AP, the first AP can coordinate or support with the second AP on (X+K) number of TWT schedules or TWT agreements in the BSS of the second AP. In some embodiments, K can be a positive or negative number. In some embodiments, K can be a whole number, for example, −3, −1, 0, 1, 4. In some embodiments, (X+K) can be 0 or any positive integer. In some implementations, when (X+K) is ‘0’, it may indicate no commitment for the reciprocation.

According to some embodiments, when a first AP transmits a C-TWT invitation frame to a second AP, the first AP may indicate a type of TWT based coordination that the first AP is soliciting from the second AP. The type of TWT based coordination may be, for example, a broad TWT (not a Restricted TWT), a Restricted TWT, or an individual TWT.

In some embodiments, upon receiving a C-TWT invitation frame from a first AP, a second AP may transmit a C-TWT invitation response frame to the first AP. The C-TWT invitation response frame may indicate whether the second AP intends to participate in the TWT based multi-AP coordination with the first AP. When the second AP intends to participate in the TWT based multi-AP coordination, the second AP may indicate the acceptance of participation. Otherwise, the second AP may indicate the rejection of participation.

In some embodiments, upon receiving a C-TWT invitation from a first AP, the second AP may transmit a C-TWT invitation response frame, indicating an alternative coordination. In some implementations, the C-TWT invitation response frame may indicate that the second AP does not agree with one or more coordination parameters or information that the first AP shared with the second AP in the C-TWT invitation frame. Furthermore, the C-TWT invitation response frame may indicate that if the first AP changes or modifies certain parameters or information, the second AP may agree to participate in the TWT based multi-AP coordination. In some implementations, the second AP may indicate acceptable parameter values as alternatives in the C-TWT invitation response frame.

In some embodiments, when the first AP receives a C-TWT invitation response frames from one or more other APs, the first AP may create a multi-AP coordination set for TWT-based multi-AP coordination. In some implementations, when the first AP transmits a C-TWT invitation frame to a second AP and a third AP, and receives a C-TWT invitation response frame from the second AP and the third AP that indicate acceptance of the participation, the first AP may form a multi-AP coordination group with the second AP and the third AP.

In some embodiments, a first AP initiates a C-TWT process and successfully negotiates on TWT parameters with a second AP on the TWT based multi-AP coordination. In this scenario, when the TWT based multi-AP coordination is for a first broadcast TWT schedule in the BSS operated by the first AP, then the second AP may also advertise a second broadcast TWT schedule in the BSS operated by the second AP. In some implementations, the parameters of the second broadcast TWT schedule may be aligned with the parameters of the first broadcast TWT schedule, for example, based on the adjustment of timing synchronization functions of the respective BSSs operated by each AP. In some embodiments, if a first broadcast TWT schedule in a first AP is a restricted TWT schedule, the second AP or the STAs associated with the second AP may ensure any of their TXOPs end before the start of the R-TWT SP corresponding to a second broadcast TWT schedule which is aligned with the first broadcast TWT schedule. In other words, a STA, which is a TXOP holder, in the second AP's BSS may ensure the TXOP ends before the start time of any active R-TWT SPs, advertised by the second AP, which correspond to a second broadcast TWT schedule which is aligned with the first broadcast TWT schedule. Similarly, the second AP which is a TXOP holder may ensure the TXOP ends before the start time of any active R-TWT SPs, advertised by itself, which corresponds to a second broadcast TWT schedule which is aligned with the first broadcast TWT schedule.

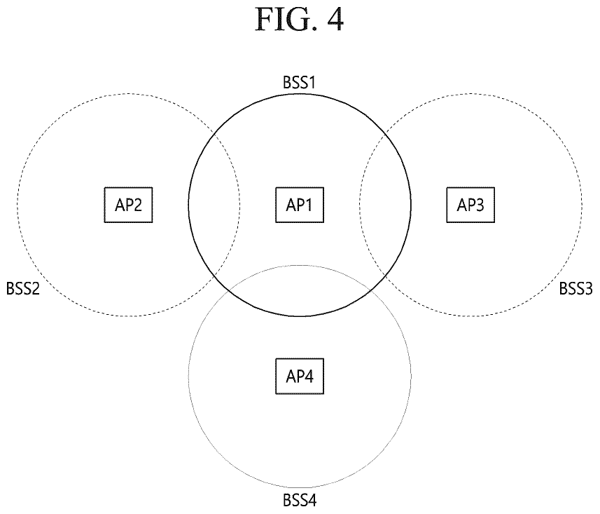

FIG. 4 shows an example architecture for coordinated TWT negotiation in accordance with an embodiment.

In FIG. 4, AP 1, AP 2, AP 3, and AP 4 establish BSS 1, BSS2, BSS 3, and BSS4, respectively. Additionally, AP 1, AP 2, AP 3, and AP 4 are members of a TWT coordination AP set and are participating in the TWT multi-AP coordination. In FIG. 4, the APs may be TWT scheduling APs in their BSSs. In this disclosure, the TWT scheduling AP is an AP that schedules broadcast TWTs and provides these broadcast TWT schedules in a broadcast TWT element. The TWT scheduled STA is a STA that follows the broadcast TWT schedules provided in a broadcast TWT element. The APs participating in the TWT multi-AP coordination may directly exchange frames among the APs to negotiate the TWT multi-AP coordination. This topology may be referred to as ‘Type-1 architecture for coordinated TWT (C-TWT) negotiation’ in this disclosure.

In an embodiment, negotiations between APs for TWT based multi-AP coordination may be controlled by a controller, for example, a TWT central controller.

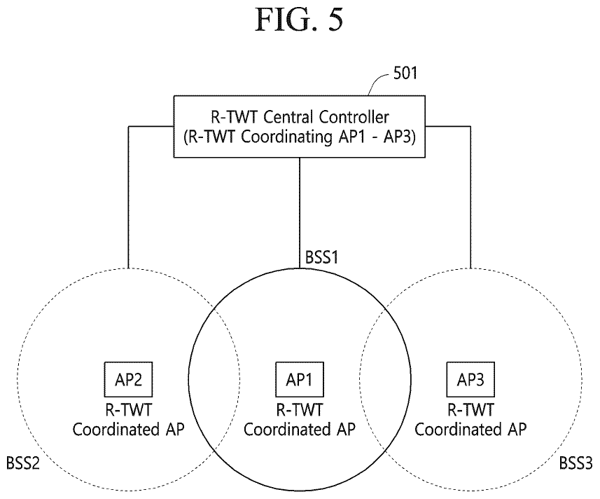

FIG. 5 shows another example architecture for C-TWT negotiation in accordance with an embodiment.

In FIG. 5, AP 1, AP 2, and AP 3 establishes BSS 1, BSS 2, and BSS 3, respectively. All three APs are connected to a TWT central controller 501. The TWT central controller 501 coordinates AP 1, AP 2, and AP 3 for C-TWT negotiation, and AP 1, AP2, and AP 3 serve as R-TWT coordinated APs. In the example of FIG. 5, the APs support the R-TWT operation to protect latency sensitive traffic. This topology may be referred to as ‘Type-2 architecture for C-TWT negotiation’ in this disclosure.

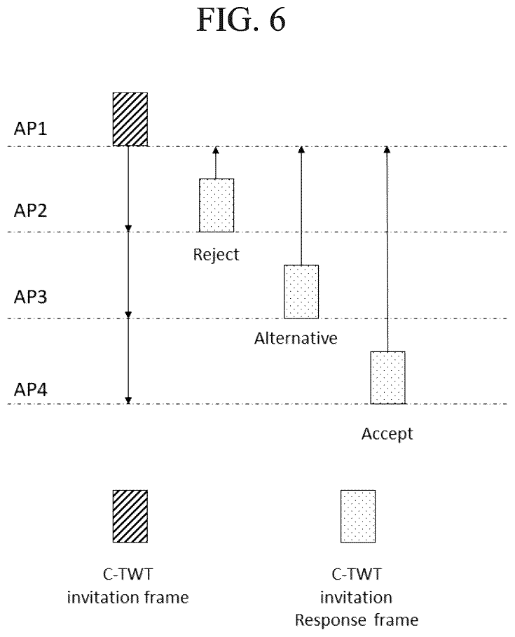

FIG. 6 shows an example pre-negotiation phase in Type 1 architecture for C-TWT negotiation in accordance with an embodiment. This example depicted in FIG. 6 is based on the topology of FIG. 4. The operation depicted in FIG. 6 is for illustration purposes and does not limit the scope of this disclosure to any particular implementations.

In FIG. 6, AP 1, AP 2, AP 3, and AP 4 establish BSS 1, BSS 2, BSS 3, and BSS 4, respectively. In this example, AP 1 is a TWT scheduling AP in BSS 1 and transmits a C-TWT invitation frame to AP 2, AP 3, and AP 4, solicitating participation in the TWT based multi-AP coordination with the AP 1.

In response to the C-TWT invitation frame, AP 2, AP3 and AP 4 respond by sending C-TWT invitation response frames to AP 1. AP 2 rejects the participation, and AP 3 suggests alternative changes to one or more coordination parameters indicated in the C-TWT invitation frame. AP 4 accepts participation of the TWT based multi-AP coordination.

Then, when the AP 1 accepts the alternatives from the AP 2, the AP 1 forms a C-TWT coordination set with the AP 3 and AP 4. Otherwise, the AP 1 forms the C-TWT coordination set with AP 4.

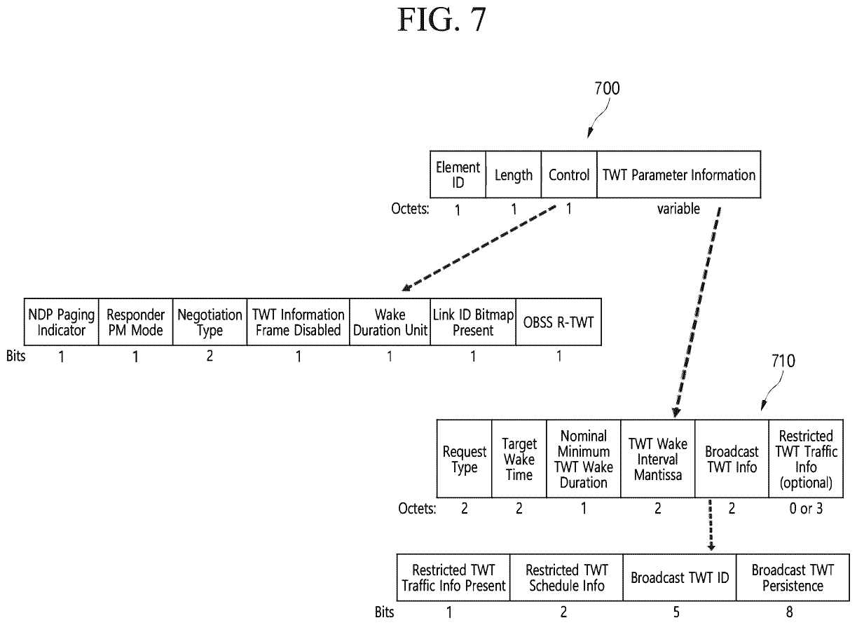

FIG. 7 shows an example format of the TWT element in accordance with an embodiment.

In FIG. 7, the TWT element 700 may include an Element identifier (ID) field, a length field, a Control field, and a TWT Parameter Information field. The Element ID field may include information to identify the TWT element 700. The Length field may indicate a length of the TWT element 700.

The Control field may include a null data PPDU (physical layer protocol data unit) (NDP) Paging Indicator subfield, a Responder power management (PM) Mode subfield, a Negotiation Type subfield, a TWT Information Frame Disabled subfield, a Wake Duration Unit subfield, a Link ID Bitmap Present subfield, and an OBSS R-TWT subfield. The NDP Paging Indicator subfield may indicate whether an NDP paging field is present or not in an Individual TWT Parameter Set field. The Responder PM Mode subfield may indicate the power management mode, such as active mode and power save (PS) mode. The negotiation Type subfield may indicate whether the information included in the TWT element is for the negotiation of parameters of broadcast or individual TWT or Wake TBTT (target beacon transmission time) interval. The MSB (most significant bit) of the Negotiation Type subfield is the Broadcast field which indicates if one or more Broadcast TWT Parameter Sets are contained in the TWT element. The TWT Information Frame Disabled subfield may indicate whether the reception of TWT information frame is disabled by the STA. The Wake Duration Unit subfield may indicate the unit of the Nominal Minimum TWT Wake Duration subfield in the Broadcast TWT Parameter Set field. The Link ID Bitmap Present subfield may indicate the presence of the Link ID Bitmap field in the Individual TWT Parameter Set field. The OBSS R-TWT subfield may indicate whether the R-TWT schedules corresponding to the Broadcast TWT Parameter Set fields in the TWT element are the R-TWT schedule of the neighboring BSS. When the OBSS R-TWT subfield is set to ‘1’, it may indicate that the R-TWT schedules in the TWT element are the R-TWT schedule of the neighboring BSS. Otherwise, it indicates that there is no neighboring BSS's R-TWT schedule in the TWT element.

The TWT Parameter information field includes an individual TWT parameter set field or one or more Broadcast TWT Parameter Set fields. For the convenience of description, FIG. 10 illustrates the Broadcast TWT Parameter Set fields. The Broadcast TWT Parameter Set field 1010 may include a Request Type field, a Target Wake Time field, a Nominal Minimum TWT Wake Duration field, a TWT Wake Interval Mantissa field, a Broadcast TWT Info (Information) field, and an optional Restricted TWT traffic Info field. The Request Type field includes information of the TWT element. The Target Wake Time field may include an unsigned integer corresponding to a TSF (time synchronization function) time for the TWT scheduled STA to wake up. The Target Wake Time field may indicate the start time of the TWT service period (SP) on the corresponding link. The Nominal Minimum TWT Wake Duration field may indicate the minimum amount of time that the TWT scheduled STA is expected to be awake in order to complete the frame exchanges for the period of TWT wake interval. The TWT wake interval is the average time that the TWT scheduled STA expects to elapse between successive TWT SPs. The TWT Wake Interval Mantissa field may indicate the value of the mantissa of the TWT wake interval value. The Broadcast TWT Info field may include information related to the broadcast TWT, such as a restricted TWT traffic info present field, a restricted TWT schedule info field, a Broadcast TWT ID field and a Broadcast TWT Persistence field. The restricted TWT traffic info present field indicates whether the restricted TWT traffic info field is present. The restricted TWT schedule info field indicates whether an active R-TWT schedule is active. The Broadcast TWT ID field indicates a specific broadcast TWT for which the transmitting STA is providing TWT parameters. The Broadcast TWT persistence field indicates the number of TBTTs during which the Broadcast TWT SPs corresponding to this broadcast TWT parameter set are present. In some embodiments, the Broadcast TWT persistence field may provide a parameter indicating a time when the updated TWT parameter set corresponding to the updated TWT schedule will be effective.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A first access point (AP) in a wireless network, the first AP device comprising:
a memory; and
a processor coupled to the memory, the processor configured to cause:
generating an invitation frame to solicit participation in a multi-AP coordination, the invitation frame including one or more coordination information to share with one or more second APs;
transmitting the invitation frame to the one or more second APs;
receiving a response frame from the one or more second APs; and
forming a multi-AP coordination set including at least one second AP based on the response frame.

2. The first AP of claim 1, wherein the invitation frame includes capability information or limitation information for the first AP.

3. The first AP of claim 1, wherein the invitation frame includes load information of the first AP

4. The first AP of claim 1, wherein the invitation frame includes benefit information that the one or more second APs gain when the one or more second APs participate in the multi-AP coordination.

5. The first AP of claim 1, wherein the invitation frame indicates that the first AP reciprocates by participating in a multi-AP coordination requested by the one or more second APs.

6. The first AP of claim 1, wherein the invitation frame indicates a type of a target wake time (TWT) operation that is shared with the one or more second APs.

7. The first AP of claim 1, wherein the response frame indicates an acceptance, a rejection, or an alternative suggestion in response to the invitation frame.

8. The first AP of claim 1, wherein the processor is further configured to cause:
transmitting, to one or more stations (STAs) associated with the first AP, a TWT schedule or a TWT agreement that is aligned with the one or more TWT schedule or TWT agreements transmitted by the one or more second APs that participate in the multi-AP coordination.

9. The first AP of claim 8, wherein the TWT schedule is a restricted TWT schedule that is associated with latency sensitive traffic.

10. The first AP of claim 9, wherein the first AP is a transmission opportunity (TXOP) holder, and the processor is further configured to cause:
ensuring a TXOP ends before a start time of restricted TWT service period that is advertised by the first AP.

11. A first access point (AP) in a wireless network, the first AP device comprising:
a memory; and
a processor coupled to the memory, the processor configured to cause:
receiving, from a second AP, an invitation frame that solicit participation in a multi-AP coordination, the invitation frame including one or more coordination information to share with the first AP;
transmitting a response frame to second AP; and
participating in the multi-AP coordination.

12. The first AP of claim 11, wherein the invitation frame includes capability information or limitation information of the second AP.

13. The first AP of claim 11, wherein the invitation frame includes load information of the second AP.

14. The first AP of claim 11, wherein the invitation frame includes benefit information that the first AP gains when the first AP participates in the multi-AP coordination.

15. The first AP of claim 11, wherein the invitation frame indicates that the second AP reciprocates by participating in a multi-AP coordination requested by the first AP.

16. The first AP of claim 11, wherein the invitation frame indicates a type of a target wake time (TWT) operation that is shared with the first AP.

17. The first AP of claim 11, wherein the response frame indicates an acceptance or an alternative suggestion in response to the invitation frame.

18. The first AP of claim 11, wherein the processor is further configured to cause:
transmitting, to one or more stations (STAs) associated with the first AP, a TWT schedule or a TWT agreement that is aligned with a TWT schedule or a TWT agreement transmitted by the second AP.

19. The first AP of claim 18, wherein the TWT schedule is a restricted TWT schedule that is associated with latency sensitive traffic.

20. The first AP of claim 19, wherein the first AP is a transmission opportunity (TXOP) holder, and the processor is further configured to cause:
ensuring a TXOP ends before a start time of restricted TWT service period that is advertised by the first AP.
